(19) United States
(12) Patent Application Publication
(10) Pub. No.: US 2012/0230560 A1
(43) Pub. Date: Sep. 13, 2012

(54) SCHEME FOR DETECTION OF FRAUDULENT MEDICAL DIAGNOSTIC TESTING RESULTS THROUGH IMAGE RECOGNITION

(75) Inventors: Lawrence Spitz, Philadelphia, PA (US); John M. Gauch, Fayetteville, AR (US); Richard Kniffin, Lancaster, PA (US); Lori Smith, Sicklerville, NJ (US)

(73) Assignee: PATTERN ANALYSIS, INC., Philadelphia, PA (US)

(21) Appl. No.: 13/416,356

(22) Filed: Mar. 9, 2012

Related U.S. Application Data
(60) Provisional application No. 61/450,647, filed on Mar. 9, 2011.

(51) Int. Cl. G06K 9/46

(52) U.S. Cl. 382/128

(57) ABSTRACT

A scheme for extracting and comparing graphs from medical reports to detect duplicates that may indicate fraudulent medical diagnostic testing results, due, e.g., to billing or insurance fraud. Domain knowledge is used to pre-process input documents and automatically extract graph images. These images are stored in a database and compared to one other using a distance-based comparison metric that is robust to noise and other image acquisition artifacts. Graphs are compared in blocks of 1000 images at a time using a two-pass comparison algorithm to identify the top matches for each graph. If a graph on the page currently being analyzed is identified as a close enough match to a known graph in the database (e.g., the graph extracted from the current patient's medical record appears to be identical to the graph of a different patient), then the page is flagged as potentially being evidence of fraudulent activity.

### CROSS-REFERENCE TO RELATED APPLICATION

This application claims priority to co-pending U.S. Provisional Patent Application Ser. No. 61/450,647, filed Mar. 9, 2011, the disclosure of which is incorporated herein by reference in its entirety.

### BACKGROUND OF THE INVENTION

1. Field of the Invention

The present invention relates, generally, to the detection of fraud in health care billing activities, and more specifically but not exclusively, to the identification of fraudulent medical documentation used in connection with such activities.

2. Description of the Related Art

Billing fraud in a health care setting involves intentional concealment, misrepresentation, and/or fabrication of information for the specific purpose of causing health care benefits to be paid to an individual or group. Billing fraud typically takes the form of insurance fraud committed by insurance plan members and/or health care providers (although other forms are possible, such as staged automobile accidents or exaggerated claims that defraud defendants and parties other than insurance companies).

Insurance fraud committed by members might include, e.g., obtaining payment for ineligible members and/or dependents, alteration of information on enrollment forms, concealment of pre-existing conditions, failure to report other coverage, prescription drug fraud, and/or failure to disclose claims that were a result of a work-related injury.

Insurance fraud committed by providers might include, e.g., claims submitted by bogus physicians, billing for services not rendered, billing for higher levels of services than those actually provided, diagnosis or treatments that are outside the scope of practice, alteration of information on claims submissions, and/or providing services while under suspension or when a license has been revoked.

Diagnostic testing is an important source of revenue for health care providers. The results and findings of diagnostic tests are used to justify both treatment and further testing. Such test results also provide objective evidence of bodily injury, which pierces the so-called “verbal threshold” for bodily injury claims, thereby increasing the amount of money that an injured party can potentially recover.

It has been estimated that, in the metropolitan New York City area, over 60% of automobile accident bodily injury claims contain fraudulent medical documentation. Such documentation includes medical reports containing altered medical history and/or examination findings and often involves the misrepresentation of medical diagnostic testing results.

To obtain reimbursement, a medical provider submits a copy of diagnostic testing reports along with corresponding medical billing documentation. Many insurance carriers have become “paperless,” such that a packet of clinical documentation and accompanying bills are typically scanned and sent to data-processing personnel who enter Current Procedural Terminology (CPT) codes and related International Classification of Diseases (ICD) diagnosis data into a computer to request and obtain payment of the bills. The scanned documentation, including images from diagnostic testing reports, remains available online for insurance adjusters to review the records, if necessary.

Primary issues of concern for insurance carriers include verifying medical necessity and identifying overutilization of medical services based on statistical models. The investigation of such issues often misses “primary fraud,” i.e., the material misrepresentation of medical facts. These misrepresentations in narrative medical reports and in diagnostic testing results fraudulently establish medical necessity to justify the excessive utilization of services.

If a medical provider misrepresents the clinical condition of a patient in clinical narrative reports and in diagnostic testing reports, there is no conventional process to “reality-check” the narrative reports and the diagnostic testing reports to determine if fraud has been committed. In addition, if the medical provider misrepresents the services rendered through the use of improper CPT billing codes, analysis of the CPT codes themselves fail to detect such a misrepresentation, and there is no conventional process to correlate the CPT codes with narrative reports and diagnostic testing reports to determine if the services were billed properly.

### SUMMARY OF THE INVENTION

Embodiments of the present invention identify fraud by (i) evaluating the critical correlation between medical reports and actual services rendered, as revealed by the underlying clinical documents, and (ii) performing a “reality-check” of the underlying clinical documents to determine if the contents of those documents are fraudulent.

In one embodiment, the present invention provides a method for detecting irregularities in patient diagnostic data. The method includes: (a) receiving an image of a medical report page containing one or more graphs, each graph comprising a graphical representation of patient diagnostic data; (b) extracting, from the image of the medical report page, the one or more graphs; (c) comparing each of the one or more extracted graphs with one or more stored graphs to detect a potential match; and (d) generating an indicator for each detected potential match between an extracted graph and a stored graph.

In another embodiment, the present invention provides a system for detecting irregularities in patient diagnostic data. The system includes a processor adapted to: (a) receive an image of a medical report page containing one or more graphs, each graph comprising a graphical representation of patient diagnostic data; (b) extract, from the image of the medical report page, the one or more graphs; (c) compare each of the one or more extracted graphs with one or more stored graphs to detect a potential match; and (d) generate an indicator for each detected potential match between an extracted graph and a stored graph.

In a further embodiment, the present invention provides a non-transitory machine-readable medium, having encoded thereon program code, wherein, when the program code is executed by a machine, the machine implements a method for detecting irregularities in patient diagnostic data. The method includes: (a) receiving an image of a medical report page containing one or more graphs, each graph comprising a graphical representation of patient diagnostic data; (b) extracting, from the image of the medical report page, the one or more graphs; (c) comparing each of the one or more extracted graphs with one or more stored graphs to detect a potential match; and (d) generating an indicator for each detected potential match between an extracted graph and a stored graph.

### BRIEF DESCRIPTION OF THE DRAWINGS

FIG. 1 is a flow diagram of an exemplary image-analysis method for automated graph comparison, in one embodiment of the invention;

FIG. 2 is an exemplary extract from a medical record page showing a grid of graphs having uniform dimensions; and

FIG. 3 is an exemplary extract from a medical record page showing a grid of graphs having non-uniform dimensions.

### DETAILED DESCRIPTION

Each brand and/or model of medical testing equipment produces reports that are characteristic of that specific piece of equipment and software embedded within it. Moreover, for many types of medical reports that depict test results graphically (e.g., by means of one or more line graphs), it is often medically impossible for two different patients (or for one patient at two different dates and times) to have identical test result graphics. Embodiments of the present invention employ knowledge of how medical reports should appear to detect irregularities or anomalies in patient diagnostic data, which can be used as a component of a scheme for detecting fraud.

In one embodiment, a method for detecting irregularities in patient diagnostic data involves two phases:

Phase 1 (Extraction): Before the appropriate analytical techniques can be automatically applied, the type or class of document is first determined. Phase 1 involves analyzing a stream of documents for the purpose of recognizing specific types of medical documents. Once a specific type of report has been identified, that report is extracted and copied from the stream of documents along with a predetermined number of pages that appear before and after the identified report. The adjacent documents are captured in order to capture the associated medical provider bills. Graphical elements representing patient diagnostic data results are extracted so that they can be examined in the next phase.

Phase 2 (Analysis): In this phase, specific analytic techniques are automatically applied to a recognized document based on its identified type, including comparing the extracted graphical patient diagnostic data results with stored graphical patient diagnostic data results to detect duplicates, which indicates potential billing fraud.

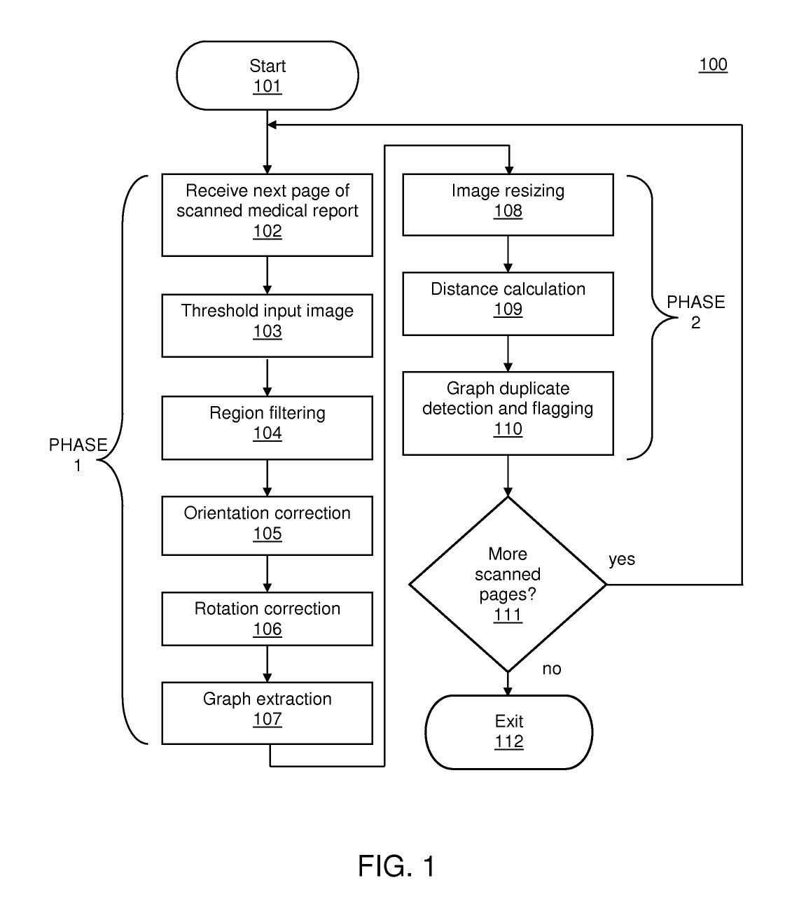

With reference to the flow diagram of FIG. 1, an exemplary image-analysis method for automated graph comparison, in one embodiment of the invention, will now be described. The goal is to extract graphs from medical reports and identify irregularities in these medical reports by comparing the graphs to one other to detect duplicates. In order to be effective, this graph comparison should be fast, accurate, and robust.

As mentioned above, the image-analysis method involves two phases, which will be described in further detail below. In Phase 1, input documents are preprocessed, and graph images are automatically extracted. In Phase 2, Euclidean distance transforms are calculated for all graph images, and this information is used to perform distance-based comparison of graph images to all other graph images to detect duplicates.

In some embodiments, Phases 1 and 2 are performed for each and every page received as input, while, in other embodiments, Phases 1 and 2 are performed for only certain pages that meet predetermined criteria (e.g., only pages whose metadata indicates that those pages contain medical reports).

### Phase 1 of Exemplary Method: Automated Graph Extraction

The process begins at step 101. At step 102, the first (or the next) page of a medical report is received. The input to the system is in the form of medical reports, which are scanned into a computer system, e.g., as portable-document format (PDF) documents, and the individual images are then converted into individual images (e.g., in JPEG format) and analyzed. The image acquisition process involving scanned paper documents typically introduces noise and other artifacts, which are removed prior to graph extraction. The process of removing such artifacts employs several techniques, including image thresholding, region filtering, orientation correction, and rotation correction.

### Image Thresholding

Once a scanned page has been received as an input image, the first task is, at step 103, to threshold the input image (which is typically scanned as a grayscale or color image) to obtain a black-and-white image, i.e., a binary digital image having only two possible values for each pixel. Because input images originate from a wide range of scanners, the intensity range of “black” pixels and “white” pixels varies significantly in a collection of images, and hence, a single static threshold is not effective.

To overcome this problem, an automatic threshold-generation algorithm is used. This algorithm calculates a threshold T based on the contents of the input image. To calculate this threshold, the algorithm first calculates an intensity histogram for the image, i.e., a graph showing the number of pixels in the image at each different intensity value found in the image, e.g., with h(i) representing the number of pixels at intensity i. This intensity histogram is used to calculate the mean intensity (mean_below) of all pixels below threshold T, the mean intensity (mean_above) of all pixels above threshold T, and the difference (separation) between mean_above and mean_below, using the following equations:

$$mean\_below = {\sum }_{i = 0 … T} h ( i ) \cdot i , \\ mean\_above = {\sum }_{i = T … 255} h ( i ) \cdot i , and$$

$$separation = mean\_above - mean\_below .$$

A search of all possible threshold T values between 0 and 255 is then performed, to find the value T such that the mean value (mean_below) of pixels less than T and the mean value (mean_above) of pixels greater than T are separated as much as possible. This optimal value of T is the value that maximizes the difference (separation) between mean_above and mean_below. The optimal threshold T is then applied to the pixels of the image to yield a black-and-white only image, with no shades of gray.

### Region Filtering

Next, at step 104, region filtering is performed, i.e., locating graph regions in the image and removing text and other small regions. This is done, e.g., by applying a recursive blob-coloring algorithm to the black-and-white image. This algorithm works by scanning the image from left to right and top to bottom and starting a new region whenever a black pixel is encountered. An 8-connected recursive region-growing algorithm is then used to find the set of black pixels connected to this starting (or “seed”) point, and each of these pixels in the output image is labeled with the current region number.

During region growing, the algorithm keeps track of the number of pixels in the region, the minimum and maximum x-coordinates (xₘᵢₙ and xₘₐₓ) of the region, and the minimum and maximum y-coordinates (yₘᵢₙ yₘₐₓ) and of the region. From this, the region width (width) is calculated as (xₘₐₓ−xₘᵢₙ), and the region height (height) is calculated as (yₘₐₓ−yₘᵢₙ). This information is used to isolate the graph regions and filter out text and other small regions using dynamic thresholds based on the overall dimensions (x_{dim}, y_{dim}) of the input image. Specifically, a region is discarded if (width<x_{dim}*U), and/or if (height<y_{dim}*U), and/or if (width*height<x_{dim}*y_{dim}*V), where U and V are user-defined constants between 0 and 1. Once noise and small regions have been removed, the resulting black-and-white image contains one or more identified graph regions.

### Orientation Correction

At step 105, orientation correction is performed. Although the majority of medical reports are scanned in a correct orientation, i.e., with the top of the document at the top of the image, some are oriented incorrectly during scanning When this happens, the input image has been rotated by either 90, 180, or 270 degrees and should be rotated by either 270, 180, or 90 degrees, respectively, to obtain the correct orientation. The approach employed to automate orientation correction is based on two assumptions, namely, (1) that input documents should have dimensions such that (y_{dim}>x_{dim}), and (2) that graphs should appear on the top half (or other designated upper portion) of the document.

When an image is obtained where (y_{dim}<x_{dim}), the center of mass of the black pixels in the image is calculated, and the image is then rotated by either 90 or 270 degrees, so that the resulting center of mass is above the midpoint (x_{dim}/2, y_{dim}/2) of the image. For images with (y_{dim}>x_{dim}), a test is performed to see if the center of mass is significantly below the center of the document. In this case, the image is rotated by 180 degrees to orient the graphs at the top of the image.

### Rotation Correction

At step 106, rotation correction is performed. Independent of large (90-degree, 180-degree, or 270-degree) rotation errors caused by improper orientation, the document-scanning process is also capable of introducing small rotation errors whenever documents are not fed perfectly straight into the scanner. Since it is a goal to compare graphs from one document to graphs from another document, rotation correction is performed as a pre-processing step prior to graph extraction, to remove the need for graph rotation at the time of comparison.

An exemplary algorithm for rotation correction uses two types of image projections along each of the (x,y)-axes to identify the optimal rotation angle for the input image. The first type of projection is a full projection that calculates (i) the y_full_projection, i.e., the total number of black pixels in each row of the graph image, and (ii) the x_full_projection, i.e., the total number of black pixels in each column of the graph image. The second type of projection is a span projection that counts (i) the y_span_projection, i.e., the number of occurrences of J consecutive black pixels in each row of the graph image, and (ii) the x_span_projection, i.e., the number of occurrences of J consecutive black pixels in each column of the graph image. The calculations are as follows:

$$x\_full \_projection [ x ] = {\sum }_{y = 0 … {y}_{di m}} 1 , if pixel ( x , y ) is black ;$$

$$y\_full \_projection [ y ] = {\sum }_{x = 0 … {x}_{di m}} 1 , if pixel ( x , y ) is black ;$$

$$x\_span \_projection [ x ] = {\sum }_{x = 0 … {x}_{dim}} 1 , \\ if all pixels from pixel ( x , y ) to pixel ( x - J , y ) are black ;$$

$$and$$

$$y\_span \_projection [ y ] = {\sum }_{y = 0 … {y}_{dim}} 1 , \\ if all pixels from pixel ( x , y ) to pixel ( x , y - J ) are black .$$

The parameter J can be assigned any value between 1 and the height or width of the input image. Good results are obtained when J is 10% of the average height or width of bounding rectangles in the graph image. For example, if the majority of bounding rectangles are 300×200 pixels, then J=0.1*(300+200)/2=25 has been demonstrated to be effective.

When the graphs in an image are aligned perfectly with the x- and y-axes, there will be a small number of very large values in the full projections, marking the coordinates where the top, bottom, left, and right sides of graphs occur. On the other hand, when there is a small rotation error in the image, the black pixels that mark the outline of each graph will be spread across a range of x- and y-values, such that the maximum values in the full projections will be smaller. Span projections behave similarly to full projections. When the graphs in an image are aligned with the x- and y-axes, the values in the span projections will be much larger than the values in the span projections when the image is rotated slightly.

The full projections and span projections are used in the search for the optimal rotation-correction angle, as follows. First, the graph image is rotated by an angle A. Next, all four projections (y_full_projection, x_full_projection, x_span_projection, and y_span_projection) are calculated. Then, the sum of the largest N values in the full projections and the sum of the largest N values in the span projections are calculated.

The parameter N can be assigned any value between 1 and the height or width of the image. Good results are obtained when N is equal to the average number of horizontal or vertical lines that occur in the bounding rectangles in a typical graph image. For example, if the majority of images have a 3×3 grid of graphs with separate bounding rectangles, there will be 3×2=6 horizontal lines and 3×2=6 vertical lines. In this case, N=6 would be a good choice.

The foregoing process is repeated for a plurality of different angles A. The angle A that yields the largest sum is chosen as the optimal angle for rotation correction, and the graph image is then rotated by this amount.

### Graph Extraction

At step 107, graph extraction is performed. Some pages of the medical reports analyzed in embodiments of the invention will typically contain groups of graphs, i.e., multiple graph images in a matrix or grid format, with varying numbers of rows and columns in varying grid arrangements. Since it is a goal to compare individual graph images to each other, these graphs should first be extracted from the groups of graphs in the input images. In most cases, the arrangement of graph images on the page follows a regular pattern that can be exploited to accurately extract the graphs.

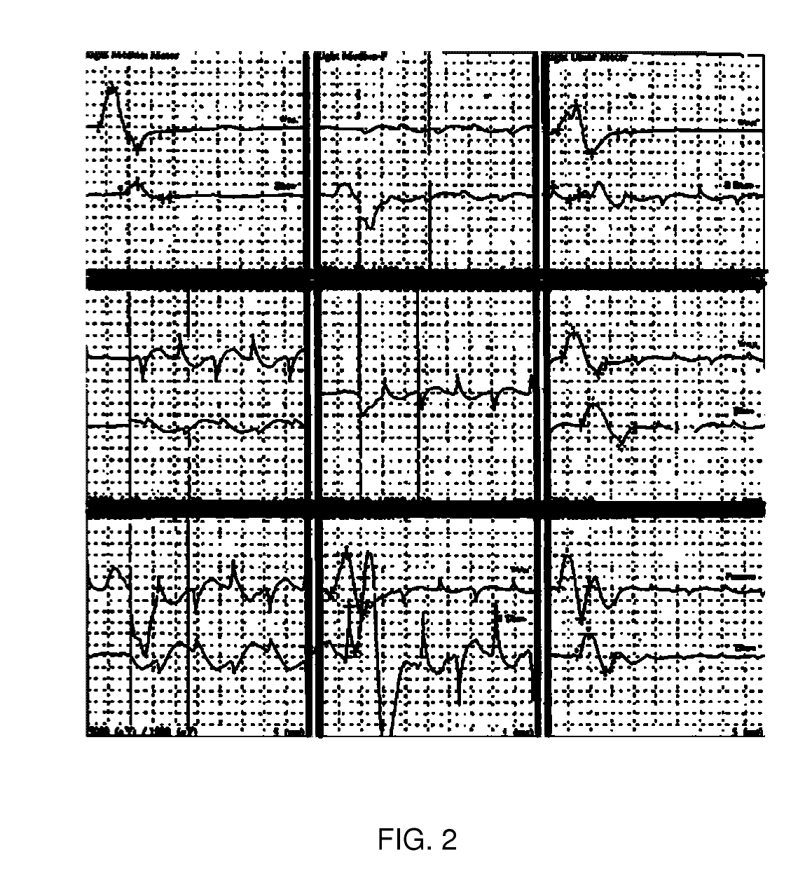

For example, when nine graphs are arranged in a 3×3 grid, as shown in FIG. 2, the boundaries of all nine graphs can be located by fitting four vertical and horizontal lines to edges that occur approximately ⅓ and ⅔ of the way across the image. If it is assumed that all nine graphs are the same size, and the separation between graphs is uniform, then there are only two parameters to consider: (i) the width of the gap (WG) between graphs in the horizontal direction, and (ii) the height of the gap (HG) between graphs in the vertical direction. For an image having a width of image_width and a height of image_height, with each individual graph having a width of graph_width and a height of graph_height, and row and col representing the row and column position of an individual graph within the image, the nine regions to be extracted from the image can be derived using the following (x,y) positions:

graph_width=(image_width−2*WG)/3,

graph_height=(image_height−2*HG)/3,

x_min(row,col)=col*(graph_width+WG),

x_max(row,col)=x_min(row,col)+graph_width,

y_min(row,col)=row*(graph_height+HG), and

y_max(row,col)=y_min(row,col)+graph_height,

where x_min, x_max, y_min, and y_max represent the range of pixel coordinates for each graph region in the image. For example, the upper left graph in a 3×3 grid will have (row,col)=(0,0). For this graph, the range of x-coordinates will be [x_min(0,0) . . . x_max(0,0)] and the range of y-coordinates will be [y_min(0,0) . . . y_max(0,0)]. The range of pixel coordinates for the other graphs in the 3×3 grid can be calculated in a similar manner.

This graph-extraction approach extends naturally to any group of N×M graphs that has uniform gaps between graphs in the horizontal and vertical directions. First, values of N and M are chosen, a search is then performed over a range of potential WG and HG values, and the number of black graph points (edges) in the image that occur along the x_min, x_max, y_min, and y_max lines are counted. The WG and HG values that result in the largest edge count are used to extract the N×M graphs from the input image.

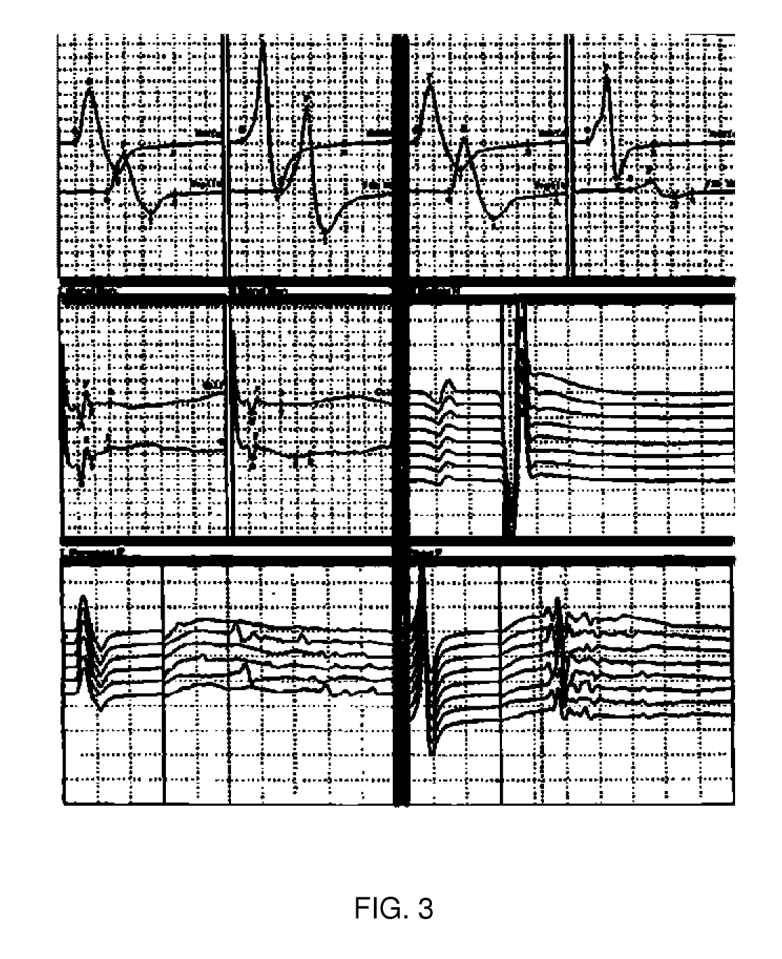

In some medical reports, there are two or more sizes of graph images in one input image. In this case, an assumption of N×M grid of uniform size graphs will result in x_min, x_max, y_min, and y_max values that are only partially correct. For example, in FIG. 3, there are three rows of graph images, with four graphs on the top row, three graphs on the second row, and two graphs on the third row. If it is assumed that N=2 and M=3, then three of the nine graphs will be correctly extracted. There will also be three incorrect graph regions that should be divided into two graphs each. On the other hand, if it is assumed that N=4 and M=3, then six of the nine graphs in the top two rows will be correctly extracted. However, three graphs on the bottom two rows will be incorrectly divided into two graph images each.

To address this situation, at least three options exist: (1) a choice of using either the 2×3 or 4×3 layout assumption can be made, based either on the number of correct graphs extracted or the number of incorrect graphs extracted, (2) graphs can be extracted using both 2×3 and 4×3 layout assumptions to ensure that all graphs are correctly extracted (at the expense of additional incorrect graphs being extracted), or (3) hybrid layout patterns can be introduced, where the number of graphs that occur on each row varies but the size of the WG and HG parameters remains uniform.

To simplify the representation of hybrid layouts, it is assumed that images in each row are either narrow (n) or wide (w), where w=2n. Then, all combinations of n and w are enumerated, where their total width corresponds to the image width. For example, when hybrid 4×3 layouts are considered, only five layouts are possible on each row: (n,n,n,n), (n,n,w), (n,w,n), (w,n,n), (w,w). This enables a selection of the optimal layout for graph extraction on a row-by-row basis by searching for the hybrid layout that has the most evidence of vertical edges in the expected positions. Additional factors such as geometric or textural features within each of the graph regions can also be used to distinguish the n graphs from the w graphs.

### Phase 2 of Exemplary Method: Analysis of Extracted Graphs

A goal of embodiments of the invention is to compare graphs to each other and robustly detect duplicates. After preprocessing and graph extraction takes place in Phase 1, the horizontal and vertical boundaries of each graph are aligned with the x- and y-axes of the image. Hence, the duplicate detection algorithm does not need to consider the issue of rotations while comparing graphs. Unfortunately, there is no assurance that all of the images being compared are the same size or have the same aspect ratio, so the graph comparison approach should integrate resizing

Another issue to consider is noise and other artifacts that may be introduced during the scanning process. An optimal image thresholding and region filtering process will remove many of these errors, but there may still be situations where grid lines and other features will be present in one image of a graph and absent in another image of the same graph. To handle this situation, an approach is used that employs a distance-based graph-comparison metric that is robust to such digitizing artifacts, as will be described in more detail below.

### Image Resizing

At step 108, image resizing is performed. The graph images that are extracted in Phase 1 have a wide variety of sizes and aspect ratios. If an attempt is made to compare these images directly using a pixel-by-pixel difference, then a decision should be made how to align the two graphs, and what should be done with (x,y) locations that are valid in one image, but not in the other. To avoid these issues, a choice can be made to interpolate graph images to have the same size and aspect ratio prior to calculating differences.

In one embodiment, three options exist for interpolation: (1) interpolation to a canonical (i.e., some common) image size, (2) interpolation to the smaller image size, and (3) interpolation to the larger image size. The advantage of interpolation to a canonical image size is that interpolations are performed only once for each input graph. However, it is a disadvantage that some information may be lost if the canonical size happens to be smaller than the actual graph size. The loss of information is also a problem with interpolation to the smaller image size, and so the most robust resizing approach is interpolation to the larger image size, whereby the smaller image is resized to match the dimensions of the larger image prior to comparison.

### Distance Calculation

At step 109, distance calculation is performed. Considering two graph images g1(x,y) and g2(x,y) that have been resized to have the same dimensions, the pixel difference (pixel_difference_{g1,g2}) between graphs g1 and g2 is given by the following equation:

$${pixel\_difference}_{g 1 , g 2} = {\sum }_{∀ x} {\sum }_{∀ y} \vert g 1 ( x , y ) - g 2 ( x , y ) \vert .$$

Because the two graph images are black-and-white, pixel_difference is equal to the count of the number of pixels that are different. The individual (x,y) locations of these differences are not considered in any way. If the black lines in one graph are one pixel higher than the black lines in another graph, then the value of pixel_difference will be the same as if the lines are 100 pixels apart, which can make pixel_difference a poor similarity metric. However, to overcome this problem, the total distance between black pixels in one graph image and the closest black pixel in the other graph image can be calculated. This distance-based approach will produce very different values for the graph comparison example above.

A brute-force calculation of the distances between the black pixels in two different graph images is computation-intensive. Fortunately, the pixel_distance metric can be quickly calculated if both graph images are preprocessed to calculate the distance between all pixels in an image and the closest black pixel in that image. This distance image is called the Euclidean distance transform (edt_n). Using precalculated values edt_1(x,y) for g1(x,y) and edt_2(x,y) for g2(x,y), the pixel_distance value between these graphs can be calculated using the following equations:

$$edt\_ 1 ( x , y ) = min \vert ( x , y ) - ( nx , ny ) \vert , where g 1 ( nx , ny ) = 1 , \\ edt\_ 2 ( x , y ) = min \vert ( x , y ) - ( nx , ny ) \vert , where g 2 ( nx , ny ) = 1 , \\ {pixel\_distance}_{g 1 , g 2} = {\sum }_{∀ x} {\sum }_{∀ y} g 1 ( x , y ) \cdot edt\_ 2 ( x , y ) , and$$

$${pixel\_distance}_{g 2 , g 1} = {\sum }_{∀ x} {\sum }_{∀ y} g 2 ( x , y ) \cdot edt\_ 1 ( x , y ) .$$

If a situation arises in which the black lines in g1(x,y) are one pixel above or below the black lines in g2(x,y), then pixel_distance_{g1,g2} and pixel_distance_{g2,g1} can both be expected to equal one. If the black lines in the two images are further apart, then both distances can be expected to have similar values and increase accordingly.

In a situation in which one graph image has noise or other artifacts, some grid lines and other features may be present in graph g1 and missing in graph g2. In this scenario, pixel_distance_{g1,g2} will represent the total Euclidean distance between the extra black (x,y) points in graph g1 to the nearest black pixel in graph g2. On the other hand, since graph g2 contains a subset of the black pixels in graph g1, the value of pixel_distance_{g2,g1} will be zero. Hence, the ratio of pixel_distance_{g1,g2} to pixel_distance_{g2,g1} can be used as a measure of graph overlap, and either the minimum, maximum, or average distance can be used as a metric when comparing graphs to each other.

### Graph Duplicate Detection and Flagging

At step 110, graph duplicate detection is performed. In certain embodiments of the invention, all black-and-white graph images and their corresponding Euclidean distance transform images are stored in a MySQL database with status flags that indicate whether or not a graph has been compared to all other graphs.

For purposes of simplification, method 100 is shown as processing a single graph at a time and comparing that graph to a database of graphs. However, as a practical matter, duplicates could exist within a batch of new graphs currently being analyzed. Accordingly, for thoroughness, each new graph being received should be compared not only to all graphs in the stored database, but also to all other new graphs that are currently being received and analyzed.

In furtherance of the foregoing goal, in a preferred embodiment, the graph duplicate-detection process begins by reading unprocessed graph images and edt images into memory in processing blocks of 1000 graphs at a time (or another suitable block size). Each of these black-and-white graph images and their corresponding edt images are interpolated into a canonical size to reduce computation time during the initial graph comparison.

Next, all 1000 images are compared in one processing block to all 1000 images in another processing block, and the algorithm keeps track of the top Q matches (i.e., the lowest Euclidean distances) for each graph in an array of 1000 priority queues of size Q. In one embodiment, an array-based max heap is used as an efficient data structure for implementing the priority queue, but any priority queue implementation can be used. By using a priority queue to store the Q best matches, the computation-intensive process of sorting all 1000 match scores to select the top Q matches can be avoided.

The parameter Q can be assigned any value between 1 and 1000. Small values of Q (e.g., between 1 and 10) employ very little memory to store the priority queues and have very fast computation time, but some potential graph matches may be overlooked. Large values of Q (e.g., between 100 and 1000) reduce the potential to miss graph matches, but the space and time requirements increase significantly. In practice, values of Q between 10 and 100 have been demonstrated to produce an effective trade-off between computational speed and matching accuracy.

More accurate distance calculations are then made between each of the top Q graph matches by resizing the graph image and edt image of the smaller graph to match the size of the larger graph. Finally, the graph comparison results are stored in the MySQL database for future analysis and display.

There are several advantages to using processing blocks (e.g., of 1000 graphs at a time). First, this arrangement permits the creation of a memory cache of 1000 graphs and 1000 edt images to reduce file I/O time while comparing graphs. Second, this arrangement facilitates performing graph comparison in parallel on multiple machines concurrently by breaking the duplicate-detection problem into sub-tasks of 1000×1000 graph comparisons that can be dispatched to available nodes in a cluster of processors.

If a graph on the page currently being analyzed is identified as a close enough match to a known graph in the database (e.g., corresponding to a different patient), then the page is flagged as potentially being evidence of fraudulent activity, or some other indicator is generated. Such an indicator could simply be an indicator bit stored in a database, or could include a notification, such as automatic generation of an email message to a predetermined user or other communication that identifies and/or contains one or more suspicious graphs, pages, and/or bills, for human review.

The graph duplicate detection process can also include the use of additional criteria to detect suspicious billing submissions. In this scenario, each new graph being received is not only compared with stored graphs in the database, but is also subjected to other “reality checks,” some of which might involve the use of optical character recognition (OCR) on certain scanned pages. Such “reality checks” might include, e.g., (i) verifying that the type of medical diagnostic data reflected in the graph actually corresponds to the CPT code being billed, (ii) verifying that the values of medical diagnostic data reflected in the graph are values that are actual, possible values for the diagnostic testing that was performed, and (iii) verifying that the values of medical diagnostic data reflected in the graph are values that actually provide support for the medical necessity of the services (or other item) being billed. In the event any of these “reality checks” fails, the graph being examined is flagged as potentially being evidence of fraudulent activity, in like manner to a graph discovered to be a match with a stored graph, as described above. Although the foregoing “reality check” criteria are described as being evaluated as part of the duplicate detection process, in some embodiments, such criteria could alternatively be evaluated (i) in a separate step, (ii) as part of another, different step described above, or (iii) in lieu of performing duplicate detection altogether.

At step 111, a determination is made whether additional pages are to be analyzed. If not, then, at step 112, the method terminates. If additional pages exist, then the method returns to step 102 to receive the next page to analyze.

Thus, the foregoing provides an exemplary method for extracting graphs from medical reports and comparing graphs to each other to detect duplicates that may indicate irregularities in these medical reports. Domain knowledge is used to preprocess input documents and automatically extract graph images. These graph images are stored in a database and compared to each other using a distance-based comparison metric that is robust to noise and other image acquisition artifacts. Graph comparison is performed using large blocks of images at a time using a two-pass comparison algorithm to identify the top Q matches for each graph. This graph comparison process is parallelized to run efficiently and effectively on a cluster of processors.

The following three examples describe different scenarios for which a method consistent with embodiments of the invention might be appropriate.

### EXAMPLE 1

One type of billing fraud involves fabricated electromyogram (EMG) and/or nerve conduction velocity (NCV) reports that use “recycled” waveform images, i.e., waveform images from an actual patient, where that patient is a different patient from the one whose insurance is being billed. It is essentially a medical impossibility for two EMG/NCV reports to contain the identical waveform image, even if the two reports are from the same patient but measured at two different times, or if the two reports are from different patients. Accordingly, once Phase 1 of the process has classified a document as an EMG/NCV report, Phase 2 automatically applies analytical techniques, as described above, to compare each waveform on the new EMG/NCV report with waveforms in an extensive historical database of waveforms from other reports, to identify fraudulent reutilization of waveform images by a provider who fabricates reports.

### EXAMPLE 2

A second type of billing fraud involves the fraudulent use of boilerplate medical history and examination findings. In this scenario, the provider uses essentially the same report for every patient, including identical examination findings that would normally change from patient to patient. Once Phase 1 has used automated image recognition to identify a document as a billing document and the adjacent associated clinical documents have been extracted, fraud involving the use of boilerplate medical reports that contain medically-impossible patient data can then be detected. Accordingly, in Phase 2, OCR is automatically applied to the billing documents, a visual comparison of document images is performed on the documents that were identified as billing documents, and CPT codes that were reported with the testing report are extracted and compared with the medical history and examination findings, to see whether boilerplate medical history or examination findings were used, and also whether the CPT codes correspond to the test results shown in the medical history or examination findings.

### EXAMPLE 3

A third type of billing fraud involves misrepresentation of services by using inappropriate CPT billing codes. Specific diagnostic testing can be reported legitimately only with specific CPT codes. CPT codes are governed by the American Medical Association, which defines their proper use. Since many medical diagnostic reports have a characteristic format identifiable by imaging techniques, it is possible in Phase 2 to correlate a billed CPT code with a type of report identified in Phase 1, to detect fraudulent misrepresentation of services rendered through improper billing.

### Alternative Embodiments

It should be understood that various changes in the details, materials, and arrangements of the parts which have been described and illustrated in order to explain the nature of this invention may be made by those skilled in the art without departing from the scope of the invention. For example, it should be understood that the inventive concepts of embodiments of the invention may be applied not only in systems for detecting fraud in medical documents, but also for other image-comparison and document-comparison purposes.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing embodiments of the invention. The present invention can also be embodied in the form of program code, for example, stored in a non-transitory machine-readable storage medium including being loaded into and/or executed by a machine, wherein, when the program code is loaded into and executed by a machine, such as a computer, the machine becomes an apparatus for practicing embodiments of the invention. When implemented on a general-purpose processor, the program code segments combine with the processor to provide a unique device that operates analogously to specific logic circuits.

It will be appreciated by those skilled in the art that although the functional components of the exemplary embodiments of the system of the present invention described herein may be embodied as one or more distributed computer program processes, data structures, dictionaries and/or other stored data on one or more conventional general-purpose computers (e.g., IBM-compatible, Apple Macintosh, and/or RISC microprocessor-based computers), mainframes, minicomputers, conventional telecommunications (e.g., modem, T1, fiber-optic line, DSL, satellite and/or ISDN communications), memory storage means (e.g., RAM, ROM) and storage devices (e.g., computer-readable memory, disk array, direct access storage) networked together by conventional network hardware and software (e.g., LAN/WAN network backbone systems and/or Internet), other types of computers and network resources may be used without departing from the present invention. One or more networks discussed herein may be a local area network, wide area network, internet, intranet, extranet, proprietary network, virtual private network, a TCP/IP-based network, a wireless network (e.g., IEEE 802.11 or Bluetooth), an e-mail based network of e-mail transmitters and receivers, a modem-based, cellular, or mobile telephonic network, an interactive telephonic network accessible to users by telephone, or a combination of one or more of the foregoing.

Embodiments of the invention as described herein may be implemented in one or more computers residing on a network transaction server system, and input/output access to embodiments of the invention may include appropriate hardware and software (e.g., personal and/or mainframe computers provisioned with Internet wide area network communications hardware and software (e.g., CQI-based, FTP, Netscape Navigator™, Mozilla Firefox™, Microsoft Internet Explorer™, or Apple Safari™ HTML Internet-browser software, and/or direct real-time or near-real-time TCP/IP interfaces accessing real-time TCP/IP sockets) for permitting human users to send and receive data, or to allow unattended execution of various operations of embodiments of the invention, in real-time and/or batch-type transactions. Likewise, the system of the present invention may include one or more remote Internet-based servers accessible through conventional communications channels (e.g., conventional telecommunications, broadband communications, wireless communications) using conventional browser software (e.g., Netscape Navigator™, Mozilla Firefox™, Microsoft Internet Explorer™, or Apple Safari™). Thus, the present invention may be appropriately adapted to include such communication functionality and Internet browsing ability. Additionally, those skilled in the art will recognize that the various components of the server system of the present invention may be remote from one another, and may further include appropriate communications hardware/software and/or LAN/WAN hardware and/or software to accomplish the functionality herein described.

Each of the functional components of the present invention may be embodied as one or more distributed computer-program processes running on one or more conventional general purpose computers networked together by conventional networking hardware and software. Each of these functional components may be embodied by running distributed computer-program processes (e.g., generated using “full-scale” relational database engines such as IBM DB2™, Microsoft SQL Server™, Sybase SQL Server™, or Oracle 10g™ database managers, and/or a JDBC interface to link to such databases) on networked computer systems (e.g., including mainframe and/or symmetrically or massively-parallel computing systems such as the IBM SB2™ or HP 9000™ computer systems) including appropriate mass storage, networking, and other hardware and software for permitting these functional components to achieve the stated function. These computer systems may be geographically distributed and connected together via appropriate wide- and local-area network hardware and software. In one embodiment, data stored in the database or other program data may be made accessible to the user via standard SQL queries for analysis and reporting purposes.

Primary elements of embodiments of the invention may be server-based and may reside on hardware supporting an operating system such as Microsoft Windows NT/2000™ or UNIX.

Components of a system consistent with embodiments of the invention may include mobile and non-mobile devices. Mobile devices that may be employed in the present invention include personal digital assistant (PDA) style computers, e.g., as manufactured by Apple Computer, Inc. of Cupertino, Calif., or Palm, Inc., of Santa Clara, Calif., and other computers running the Android, Symbian, RIM Blackberry, Palm webOS, or iPhone operating systems, Windows CE™ handheld computers, or other handheld computers (possibly including a wireless modem), as well as wireless, cellular, or mobile telephones (including GSM phones, J2ME and WAP-enabled phones, Internet-enabled phones and data-capable smart phones), one- and two-way paging and messaging devices, laptop computers, etc. Other telephonic network technologies that may be used as potential service channels in a system consistent with embodiments of the invention include 2.5G cellular network technologies such as GPRS and EDGE, as well as 3G technologies such as CDMA1xRTT and WCDMA2000, and 4G technologies. Although mobile devices may be used in embodiments of the invention, non-mobile communications devices are also contemplated by embodiments of the invention, including personal computers, Internet appliances, set-top boxes, landline telephones, etc. Clients may also include a PC that supports Apple Macintosh™, Microsoft Windows 95/98/NT/ME/CE/2000/XP/Vista/7™, a UNIX Motif workstation platform, or other computer capable of TCP/IP or other network-based interaction. In one embodiment, no software other than a web browser may be required on the client platform.

Alternatively, the aforesaid functional components may be embodied by a plurality of separate computer processes (e.g., generated via dBase™, Xbase™, MS Access™ or other “flat file” type database management systems or products) running on IBM-type, Intel Pentium™ or RISC microprocessor-based personal computers networked together via conventional networking hardware and software and including such other additional conventional hardware and software as may be necessary to permit these functional components to achieve the stated functionalities. In this alternative configuration, since such personal computers typically may be unable to run full-scale relational database engines of the types presented above, a non-relational flat file “table” (not shown) may be included in at least one of the networked personal computers to represent at least portions of data stored by a system according to the present invention. These personal computers may run the Unix, Microsoft Windows NT/2000™ or Windows 95/98/NT/ME/CE/2000/XP/Vista/7™ operating systems. The aforesaid functional components of a system according to the present invention may also include a combination of the above two configurations (e.g., by computer program processes running on a combination of personal computers, RISC systems, mainframes, symmetric or parallel computer systems, and/or other appropriate hardware and software, networked together via appropriate wide- and local-area network hardware and software).

A system according to the present invention may also be part of a larger system including multi-database or multi-computer systems or “warehouses” wherein other data types, processing systems (e.g., transaction, financial, administrative, statistical, data extracting and auditing, data transmission/reception, and/or accounting support and service systems), and/or storage methodologies may be used in conjunction with those of the present invention to achieve additional functionality (e.g., as part of a system operated by a health insurance company or health-care provider).

In one embodiment, source code may be written in an object-oriented programming language using relational databases. Such an embodiment may include the use of programming languages such as C++ and toolsets such as Microsoft's .Net™ framework. Other programming languages that may be used in constructing a system according to the present invention include Java, HTML, Perl, UNIX shell scripting, assembly language, Fortran, Pascal, Visual Basic, and QuickBasic. Those skilled in the art will recognize that the present invention may be implemented in hardware, software, or a combination of hardware and software.

Accordingly, the terms “computer” or “system,” as used herein, should be understood to mean a combination of hardware and software components including at least one machine having a processor with appropriate instructions for controlling the processor. The terms “computer” or “system” can be used to refer to more than a single computing device, e.g., multiple personal computers, or one or more personal computers in conjunction with one or more other devices, such as a router, hub, packet-inspection appliance, firewall, etc.

It should also be appreciated from the outset that one or more of the functional components may alternatively be constructed out of custom, dedicated electronic hardware and/or software, without departing from the present invention. Thus, the present invention is intended to cover all such alternatives, modifications, and equivalents as may be included within the spirit and broad scope of the invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention. It should also be recognized that one or more of the various image-processing steps and algorithms discussed above can be applied either to a number of medical report pages, or only to one page, or only to a portion of a page, or only to one graph or portion of a graph.

The term “graph,” as used herein, refers to any graphical representation of patient diagnostic data in any form, including graphical and/or text, and is not limited to any particular type or format of graphical representation. Such graphs may include, e.g., numerical test results or other data in the form of a chart, bar graph, line graph, or other graph; imaging results, such as graphical results of X-rays, magnetic resonance imaging (MRI), ultrasounds, computer-aided tomography (CAT) scans, positron emission tomography (PET) scans, and the like; data in only text form, such as blood or urine test results, insurance claim submission forms, and the like; or combinations of graphical and text elements.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments.

Although the invention has been set forth in terms of the exemplary embodiments described herein and illustrated in the attached documents, it is to be understood that such disclosure is purely illustrative and is not to be interpreted as limiting. Consequently, various alterations, modifications, and/or alternative embodiments and applications may be suggested to those skilled in the art after having read this disclosure. Accordingly, it is intended that the invention be interpreted as encompassing all alterations, modifications, or alternative embodiments and applications as fall within the true spirit and scope of this disclosure.

It will be further understood that various changes in the details, materials, and arrangements of the parts which have been described and illustrated in order to explain the nature of this invention may be made by those skilled in the art without departing from the scope of the invention as expressed in the following claims.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

We claim:

1. A computer-implemented method for detecting irregularities in patient diagnostic data, the method comprising:
(a) the computer receiving an image of a medical report page containing one or more graphs, each graph comprising a graphical representation of patient diagnostic data;
(b) the computer extracting, from the image of the medical report page, the one or more graphs;
(c) the computer comparing each of the one or more extracted graphs with one or more stored graphs to detect a potential match;
(d) the computer generating an indicator for each detected potential match between an extracted graph and a stored graph.

2. The invention of claim 1, further comprising, prior to step (c), thresholding at least a portion of the image to obtain a binary digital image.

3. The invention of claim 2, wherein the thresholding comprises:
generating an intensity histogram for the at least a portion of the image;
using the intensity histogram to find a threshold value that maximizes the difference between the mean intensity of all pixels below the threshold and the mean intensity of all pixels above the threshold; and
generating a binary digital image by applying the found threshold value to the pixels of the at least a portion of the image.

4. The invention of claim 1, further comprising, prior to step (c), performing region filtering to at least a portion of the image to eliminate parts of the image that do not contain graphs.

5. The invention of claim 4, wherein the region filtering comprises executing an 8-connected recursive region-growing algorithm to isolate graph regions.

6. The invention of claim 1, further comprising, prior to step (c), correcting the orientation of at least a portion of the image by rotating the at least a portion of the image by a multiple of 90 degrees.

7. The invention of claim 6, wherein the multiple of 90 degrees is selected based on at least one assumption selected from the group consisting of: (i) the image of the medical report page always has a length that exceeds its width, and (ii) graphs always appear on an upper portion of the image of the medical report page.

8. The invention of claim 1, further comprising, prior to step (c), performing rotation correction by rotating at least a portion of the image by a number of degrees other than a multiple of 90.

9. The invention of claim 8, wherein the number of degrees is determined by an algorithm that employs at least one image projection along an axis.

10. The invention of claim 1, further comprising, prior to step (c), extracting individual graphs from a group of graphs in at least a portion of the image.

11. The invention of claim 10, wherein the group of graphs contains at least two graphs having differing dimensions from one another.

12. The invention of claim 1, further comprising, prior to step (c), resizing at least one graph.

13. The invention of claim 12, wherein the resizing comprises enlarging the smaller of two differently-sized graphs to be compared.

14. The invention of claim 1, wherein step (c) comprises performing distance calculation to compare pixel differences between an extracted graph and a stored graph.

15. The invention of claim 14, wherein the distance calculation employs a Euclidean metric.

16. The invention of claim 1, further comprising adding the one or more extracted graphs to the one or more stored graphs.

17. The invention of claim 1, further comprising at least one of:
verifying that at least one extracted graph correctly corresponds to a Current Procedural Terminology (CPT) code being billed;
verifying that graph values or other data are within one or more expected ranges of values; and
verifying that graph values or other data are values that provide support for medical necessity of a billed item.

18. The invention of claim 1, wherein at least one graph comprises only text matter without any graphical elements.

19. A system for detecting irregularities in patient diagnostic data, the system comprising a processor adapted to:
(a) receive an image of a medical report page containing one or more graphs, each graph comprising a graphical representation of patient diagnostic data;
(b) extract, from the image of the medical report page, the one or more graphs;
(c) compare each of the one or more extracted graphs with one or more stored graphs to detect a potential match; and
(d) generate an indicator for each detected potential match between an extracted graph and a stored graph.

20. A non-transitory machine-readable medium, having encoded thereon program code, wherein, when the program code is executed by a machine, the machine implements a method for detecting irregularities in patient diagnostic data, the method comprising:
(a) receiving an image of a medical report page containing one or more graphs, each graph comprising a graphical representation of patient diagnostic data;
(b) extracting, from the image of the medical report page, the one or more graphs;
(c) comparing each of the one or more extracted graphs with one or more stored graphs to detect a potential match;
(d) generating an indicator for each detected potential match between an extracted graph and a stored graph.
